(19) United States
(12) Patent Application Publication
(10) Pub. No.: US 2025/0074720 A1
(43) Pub. Date: Mar. 6, 2025

(54) INSTANT RICE CONTAINER SEPARATION APPARATUS, AND INSTANT RICE MANUFACTURING SYSTEM COMPRISING SAME

(71) Applicant: CJ CHEILJEDANG CORPORATION, Seoul (KR)

(72) Inventors: Sang Cheol KIM, Chungcheongnam-do (KR); Soon Suk BAE, Chungcheongnam-do (KR); Yong Gyu LEE, Chungcheongnam-do (KR); Ui Cheol SHIN, Gwangju (KR); Hyun Cheol KONG, Seoul (KR); Beom Ho PARK, Seoul (KR)

(73) Assignee: CJ CHEILJEDANG CORPORATION, Seoul (KR)

(21) Appl. No.: 18/725,740

(22) PCT Filed: Nov. 18, 2022
(86) PCT No.: PCT/KR2022/018282

§ 371 Date: Jun. 28, 2024

(30) Foreign Application Priority Data
Dec. 30, 2021 (KR) 10-2021-0192908

(51) Int. Cl. B65G 47/91; B65B 43/44

(52) U.S. Cl. CPC B65G 47/918; B65B 43/44; B65G 2201/0235

(57) ABSTRACT

An instant rice container separation apparatus and an instant rice manufacturing system comprising same are disclosed. The instant rice container separation apparatus according to one embodiment of the present invention comprises: a container-supplying master which is provided at one side of an apparatus body and which allows a plurality of instant rice containers to be stacked in the height direction while overlapping and to be arranged in the lateral direction; an integrated container separation plate which is disposed in a region below the container-supplying master, and which separates the lowermost containers, arranged in the lateral direction, all at once from the containers stacked thereon; and a separation plate forward-backward driving part which is connected to the integrated container separation plate and which drives the integrated container separation plate forward and backward.

### TECHNICAL FIELD

The present invention relates to an instant rice container separation apparatus and an instant rice manufacturing system including the same, and more specifically, to an instant rice container separation apparatus, whereby, owing to a compact and efficient structure, containers can be effectively separated and disassembly and assembly can easily be performed so that cleaning tasks can be conveniently performed and thus a production preparation time can be reduced, and in addition, the possibility that foreign substances may be introduced into the containers, can be eliminated and the containers can be safely protected from contamination, and an instant rice manufacturing system including the same.

### BACKGROUND ART

Rice is manufactured by pouring a predetermined amount of water into rice and heating the rice at the temperature of around 100 (for about 30 minutes to 1 hour.

However, when you cook rice and store it without eating it right away, the moisture in the rice evaporates, the rice becomes hard, and the color of the rice changes into yellow, and thus it is difficult to eat the rice. In addition, it is known that microorganisms exist on the surface of the rice, and although general microorganisms are killed during the cooking process, heat-resistant spores are not completely killed. Thus, it is not a problem when the rice is eaten within a day, but it becomes a problem when the rice is 25 stored or distributed at room temperature for more than a day. Actually, lunch boxes sold packaged with side dishes are meant to be consumed within 7 hours from the time of manufacture.

In order to solve these problems, packaged instant rice that can be stored for a long time is being distributed on the market by reducing the number of microorganisms in the rice and killing heat-resistant spores.

This packaged instant rice tastes as good as freshly cooked rice once you heat the instant rice, so that the instant rice is used not only when traveling or on business trips, but also by people who have difficulty cooking meals on time, such as office workers, dual-income couples, or elderly people.

The typical instant rice manufacturing process includes an instant rice container insertion process, a sterilization process of sterilizing the rice in the container, a cooking process of heating and cooking the rice, a sealing process of placing a lid on the container, a post-treatment process such as sterilization and cooling of the container, and the like.

Among these processes, the instant rice container insertion process may be performed in the following order: separately supplying an instant rice container, container presence detection, container foreign substance removal, supplying a fixed amount of washed rice, chopping the washed rice, and container discharging, etc.

At this time, when supplying containers, a plurality of containers that are stacked and stacked high should be individually separated from the bottom, and then the separated containers need to be supplied to a tray of a tray conveyor, and this process is performed by so-called an instant rice container separation apparatus.

An instant rice container separation apparatus according to the related art has a series of structures in which containers loaded on a hopper are individually separated by a transfer cam and then adsorbed with a vacuum pad and supplied to the tray of the tray conveyor.

However, in the case of the related art, due to the nature of food equipment, the food equipment needs to be disassembled, cleaned, and reassembled at least once a day for use, but a disassembly method is complicated due to its structure, making cleaning difficult, and this causes a problem in that it takes a long time to prepare for production.

In addition, in the case of the related art, there is a problem that the transfer cam made of MC nylon, etc. may be vulnerable to contamination, such as foreign substances may flow into the container due to a wear phenomenon.

### PRIOR ART DOCUMENT

### Patent Document

(Patent Document 1) Korean Patent Registration No. 10-0726155 (Jun. 1, 2007)

### DISCLOSURE

### Technical Problem

The present invention provides an instant rice container separation apparatus, whereby, owing to a compact and efficient structure, containers can be effectively separated and disassembly and assembly can easily be performed so that cleaning tasks can be conveniently performed and thus a production preparation time can be reduced, and in addition, the possibility that foreign substances may be introduced into the containers, can be eliminated and the containers can be safely protected from contamination, and an instant rice manufacturing system including the same.

### Technical Solution

According to an aspect of the present invention, there is provided an instant rice container separation apparatus including: a container-supplying master which is provided at one side of an apparatus body and which allows a plurality of instant rice containers to be stacked in a height direction while overlapping and to be arranged in a lateral direction; an integrated container separation plate which is disposed in a region below the container-supplying master, and which separates the lowermost containers, arranged in 15 the lateral direction, all at once from the containers stacked thereon; and a separation plate forward-backward driving part which is connected to the integrated container separation plate and which drives the integrated container separation plate forward and backward.

The integrated container separation plate may include: a separation plate body formed as a plate body; and a plurality of container separation hole portions which are arranged in rows at equal intervals on the separation plate body and include a stepped locking portion that catches one side when the containers pass through the plurality of container separation hole portions.

Each of the container separation hole portions may be manufactured in an elliptical shape.

The stepped locking portion may have a stepped structure that is lower than the surface of the separation plate body, and an inclined surface may be further formed on each of the container separation hole portions and is inclined from a surface of the separation plate body toward the stepped locking portion.

The integrated container separation plate may further include a pair of connection flanges provided on both sidewalls of the separation plate body and connected to the separation plate forward-backward driving part.

The integrated container separation plate may be manufactured of aluminum.

The separation plate forward-backward driving part may include: a pair of separation plate supporting brackets that support the integrated container separation plate to be movable forward and backward on both sides of the integrated container separation plate; a separation forward-backward cylinder that is mounted on the separation plate supporting bracket and generates power for forward/backward movement of the integrated container separation plate; and a connector that is connected to the separation forward-backward cylinder and the integrated container separation plate and delivers power of the separation forward-backward cylinder to the integrated container separation plate.

A job change separation plate for job change may be further provided between the pair of separation plate supporting brackets, and the job change separation plate may be driven by a job change air cylinder.

The instant rice container separation apparatus may further include a container adsorption unit provided in a lower region of the integrated container separation plate and which absorb the lowermost containers to be separated.

The container adsorption unit may include: a plurality of container adsorption pad units arranged on a bottom of the containers and which adsorb the containers; an up/down slider that supports the plurality of container adsorption pad units integrally and is up/down driven together with the plurality of container adsorption pad units; a fixed support that is spaced apart from the up/down slider below the up/down slider and fixed to the frame structure of the apparatus body; an up/down driving actuator that is mounted on the fixed support, connected to the up/down slider and generates a driving force so that the up/down slider can be up/down driven; and a plurality of up/down guides that are connected to the up/down slider and the fixed support and guide an up/down operation of the up/down slider based on the fixed support.

The instant rice container separation apparatus may further include a device controller that controls an operation of the separation plate forward-backward driving unit and the container adsorption unit so that the lowermost containers can be separated from the stacked containers.

According to another aspect of the present invention, there is provided an instant rice manufacturing system including: a system body; and an instant rice container separation apparatus provided at one side of the system body and which separates and supplies instant rice containers in a stacked state, wherein the instant rice container separation apparatus includes: a container-supplying master which is provided at one side of an apparatus body and which allows a plurality of instant rice containers to be stacked in a height direction while overlapping and to be arranged in a lateral direction; an integrated container separation plate which is disposed in a region below the container-supplying master, and which separates the lowermost containers, arranged in the lateral direction, all at once from the containers stacked thereon; and a separation plate forward-backward driving part which is connected to the integrated container separation plate and which drives the integrated container separation plate forward and backward.

### Advantageous Effects

According to the present invention, owing to a compact and efficient structure, containers can be effectively separated and disassembly and assembly can easily be performed so that cleaning tasks can be conveniently performed and thus a production preparation time can be reduced, and in addition, the possibility that foreign substances may be introduced into the containers, can be eliminated and the containers can be safely protected from contamination.

### BRIEF DESCRIPTION OF THE DRAWING

FIG. 1 is a schematic configuration diagram of an instant rice manufacturing system according to an embodiment of the present invention;

FIG. 2 is a perspective view of the instant rice container separation apparatus according to an embodiment of the present invention;

FIG. 3 is a diagram illustrating FIG. 2 at different angles;

FIG. 4 is a view in which an apparatus body is removed from FIG. 2;

FIG. 5 is a diagram illustrating FIG. 4 at different angles;

FIG. 6 is an enlarged structure diagram of a region of an integrated container separation plate;

FIG. 7 is a diagram illustrating FIG. 6 at different angles;

FIG. 8 is an enlarged perspective view of an integrated container separation plate;

FIG. 9 is a perspective view of a container adsorption unit;

FIGS. 10 and 11 are diagrams illustrating FIG. 9 at different angles;

FIGS. 12 through 15 are partial operation diagrams of an instant rice container separation apparatus according to an embodiment of the present invention; and

FIG. 16 is a control block diagram of an instant rice container separation apparatus according to an embodiment of the present invention.

### DETAILED DESCRIPTION OF PREFERRED EMBODIMENTS

In order to fully understand the present invention, operational advantages of the present invention, and the objectives achieved by practicing the present invention, the accompanying drawings illustrating preferred embodiments of the present invention and the contents described in the accompanying drawings should be referred to.

Hereinafter, preferred embodiments of the present invention will be described in detail with reference to the exemplary drawings. Like reference numerals in each of the drawings represent like elements.

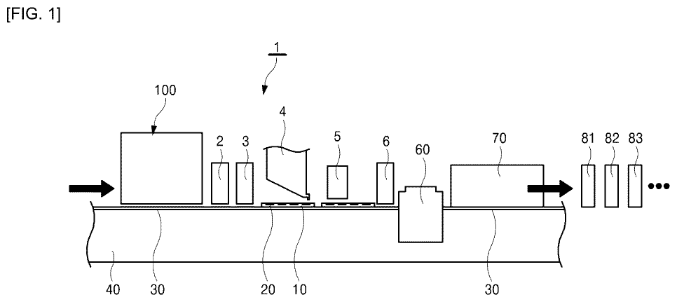

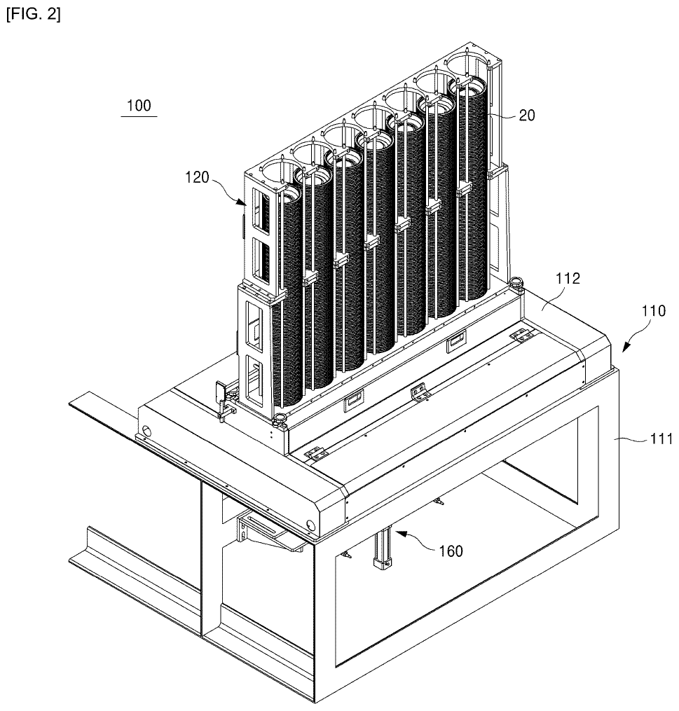

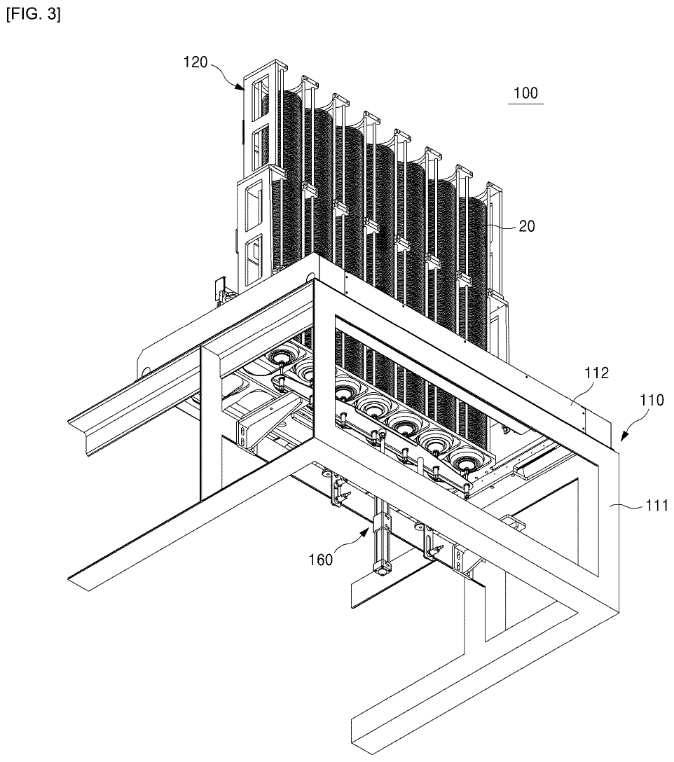

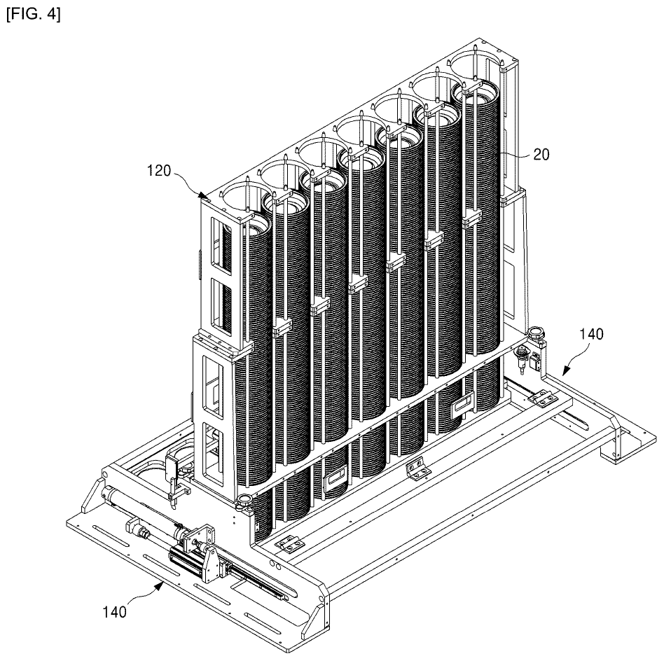

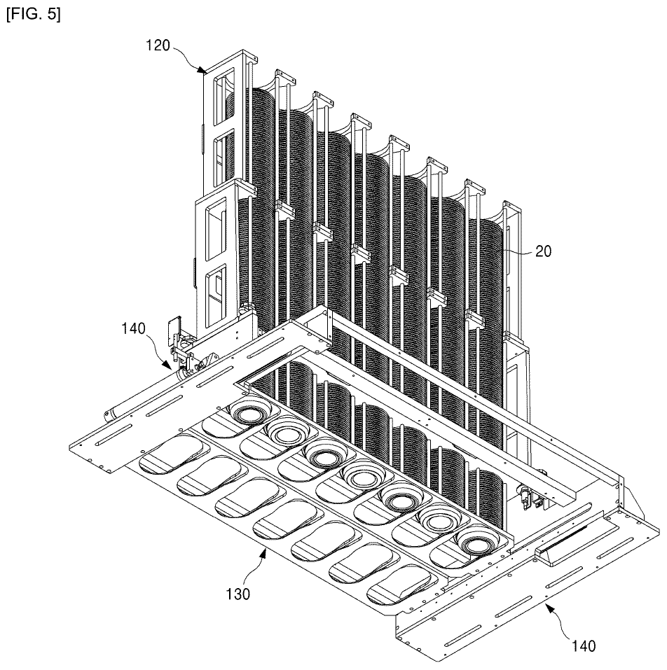

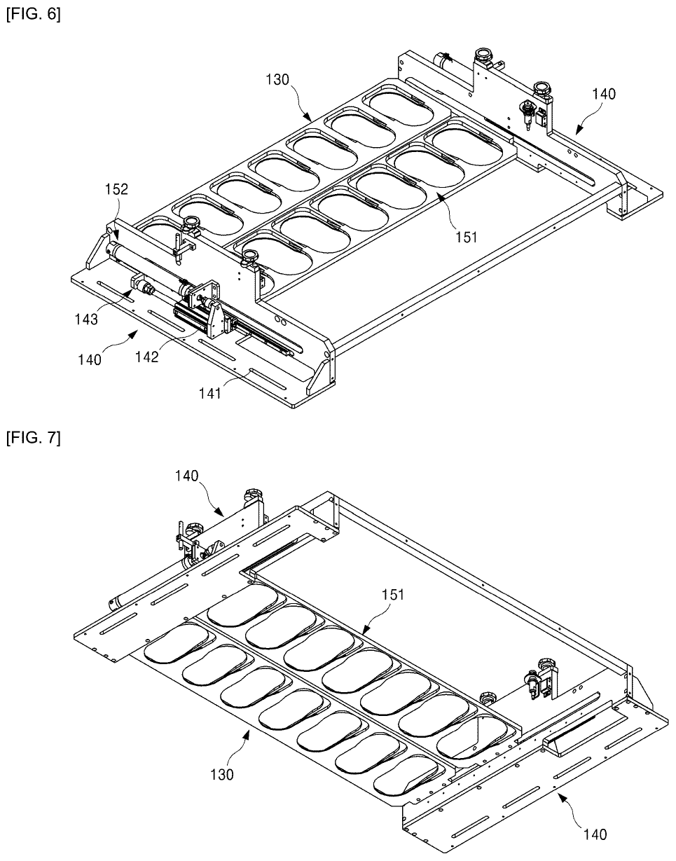

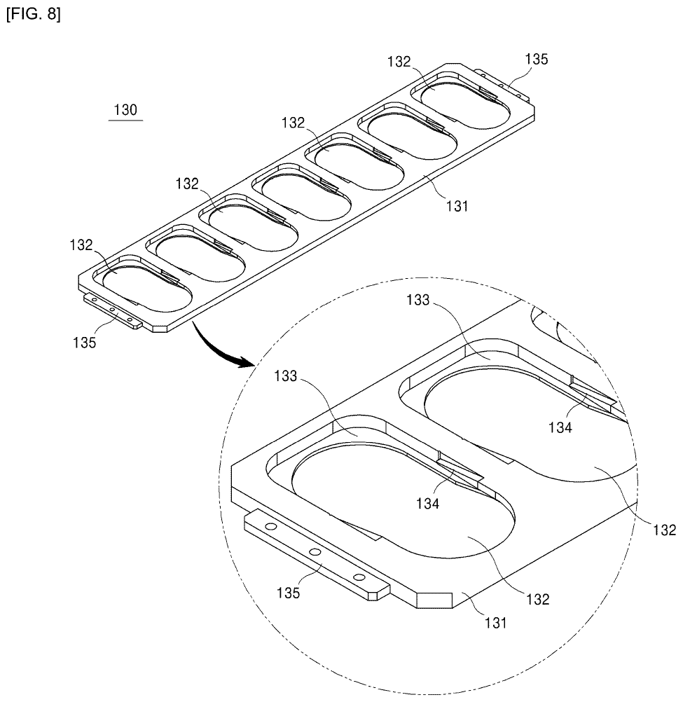

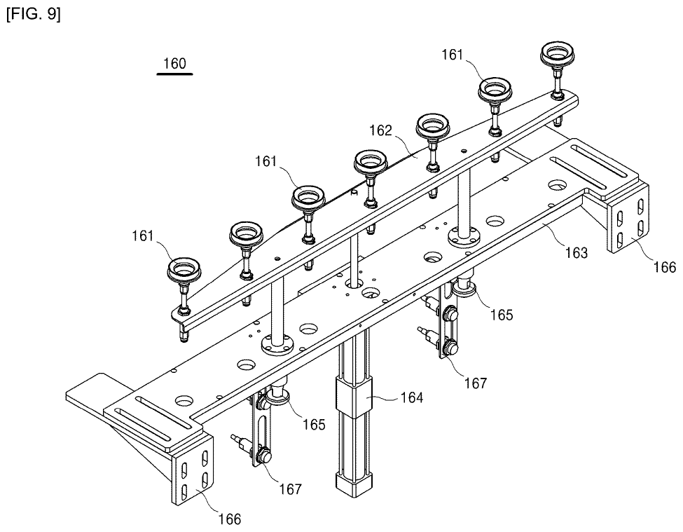

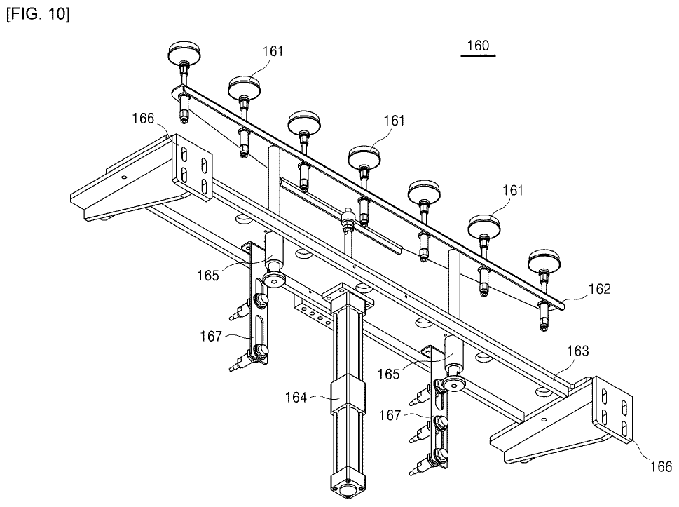

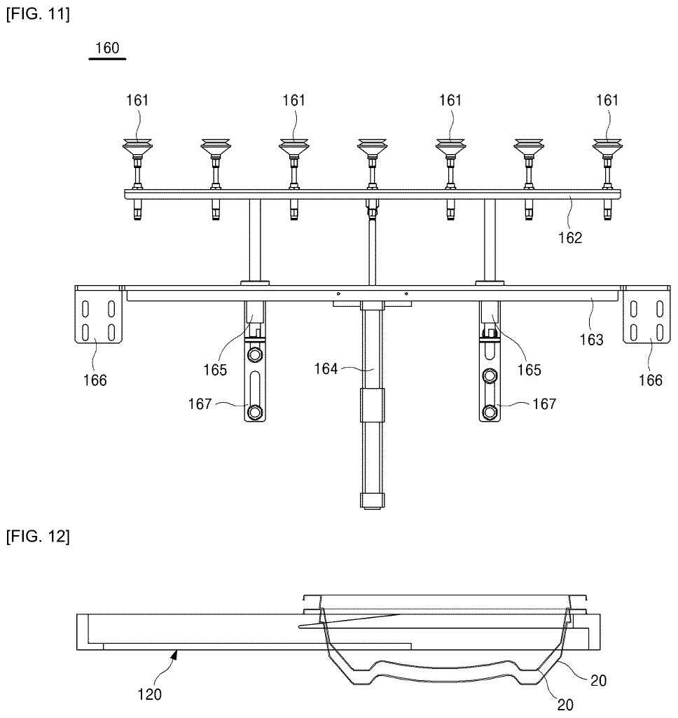

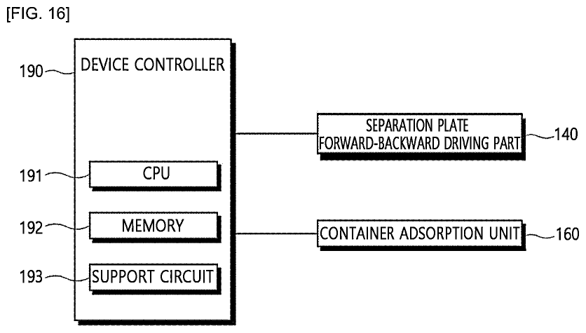

FIG. 1 is a schematic configuration diagram of an instant rice manufacturing system according to an embodiment of the present invention, FIG. 2 is a perspective view of the instant rice container separation apparatus according to an embodiment of the present invention, FIG. 3 is a diagram illustrating FIG. 2 at different angles, FIG. 4 is a view in which an apparatus body is removed from FIG. 2, FIG. 5 is a diagram illustrating FIG. 4 at different angles, FIG. 6 is an enlarged structure diagram of a region of an integrated container separation plate, FIG. 7 is a diagram illustrating FIG. 6 at different angles, FIG. 8 is an enlarged perspective view of an integrated container separation plate, FIG. 9 is a perspective view of a container adsorption unit, FIGS. 10 and 11 are diagrams illustrating FIG. 9 at different angles, FIGS. 12 through 15 are partial operation diagrams of an instant rice container separation apparatus according to an embodiment of the present invention, and FIG. 16 is a control block diagram of an instant rice container separation apparatus according to an embodiment of the present invention.

Referring to these drawings, but first to FIG. 1, the instant rice manufacturing system according to the present embodiment may include a system body 40, a tray conveyor 30 movably coupled to the system body 40, a tray 10 which is loaded onto the tray conveyor 30 and moves along the tray conveyor 30 and on which a container 20, i.e., an instant rice container 20 is mounted, an instant rice container insertion unit 1 for inserting the instant rice container 20, a steam pressurizing sterilization device 60 that pressurizes and sterilizes the container 20 filled with rice grains with steam, and a cooking device 70 for cooking rice.

Of course, a sealing device 81 which is provided in a process after the cooking device 70 and in which a lid (not shown) is placed on the container 20, a treatment device 82 for sterilizing and cooling the container 20, and a packaging device 83 for packaging may also be one component of the instant rice manufacturing system according to the present embodiment.

The instant rice container insertion unit 1 may include a combination of devices performing several processes. In other words, in the present embodiment, the instant rice container insertion unit 1 may include an instant rice container separation apparatus 100 according to the present embodiment that separates and supplies the instant rice container 20 in a stacked state, a container presence detection device 2 that detects whether the container 20 is supplied in a supply line or not, a container foreign substance removal device 3 that removes foreign substances in the container 20, a supply device 4 for a fixed amount of washed rice that supplies a fixed amount of washed rice into the container 20, a washed rice chopping device 5 that chops the fixed amount of washed rice, and a container discharge device 6 that discharges the container 20 in which the fixed amount of washed rice is supplied and a chopping work is completed.

The above-described tray conveyor 30, and a motor device for driving the tray conveyor 30 may be mounted in the system body 40 of the instant rice manufacturing system according to the present embodiment so that a continuous automatic process using these devices can be performed.

For your reference, FIG. 1 is a very schematic configuration diagram of the instant rice manufacturing system according to the present embodiment, for example, one steam pressurizing and sterilization device 60 has been applied to the instant rice manufacturing system. However, the number of steam pressurizing and sterilization devices 60 may be two or more. When a plurality of steam pressurizing and sterilization devices 60 are arranged, a sterilization process can be efficiently and more quickly performed.

Of course, considering that the cooking device 70 requires a considerable time, other devices including the cooking device 70 may be applied in plurality. Thus, the scope of rights of the present invention is not limited to the shape of the drawings.

Thus, after a container separation supply process for separating and supplying instant rice containers through the instant rice container insertion unit 1, a container presence detection process, a container foreign substance removal process, a fixed amount of washed rice supply process, a washed rice chopping process, and a container discharge process are sequentially performed, the container 20 is pressurized and sterilized with steam through the steam pressurizing and sterilization device 60 and then rice may be cooked by the cooking device 70. Thereafter, after the container 20 is covered with a lid, the container 20 is sterilized and cooled, and then packaged and released as a product.

Meanwhile, among these processes, in particular, the instant rice container insertion process may be performed through the instant rice container insertion unit 1, and the instant rice container insertion unit 1 is equipped with an instant rice container separation apparatus 100 according to the present embodiment.

Of course, an apparatus for separating and supplying containers 20 has been applied in the related art, but in the case of the related art, a transfer cam (not shown) method is used and thus, is structurally complicated. Thus, a disassembly method is complicated, which results in making cleaning difficult and it takes a long time to prepare for production.

Thus, the present embodiment proposes the instant rice container separation apparatus 100 having an efficient and compact structure as described below so as to solve these problems.

When the instant rice container separation apparatus 100 according to the present embodiment is applied, owing to a compact and efficient structure, the containers can be effectively separated and disassembly and assembly can easily be performed so that a cleaning work can be conveniently performed and thus a production preparation time can be reduced and in addition, the possibility that foreign substances may be introduced into the containers 20, can be eliminated and the containers can be safely protected from contamination.

The instant rice container separation apparatus 100 according to the present embodiment capable of providing these effects includes an apparatus body 110, and has a shape in which the following components are mounted on the apparatus body 110 according to positions.

The apparatus body 110 constitutes an exterior structure of the instant rice container separation apparatus 100 according to the present embodiment. The apparatus body 110 may include a frame structure 111 and a cover housing 112.

The frame structure 111 is manufactured by welding or bolting of a metallic frame and supports the other configurations excluding the frame structure 111. The cover housing 112 covers a lower region of a container-supplying master 120. Thus, when the cover housing 112 is removed, as shown in FIGS. 4 and 5, components such as an integrated container separation plate 130 and a separation plate forward-backward driving part 140 are exposed.

The container-supplying master 120 that is a structure provided at one side of the apparatus body 110 of the instant rice container separation apparatus supports the instant rice containers 20. In the present embodiment, the container-supplying master 120 has 7 holes. A plurality of instant rice containers 20 overlap in each hole in a height direction and are stacked, whereas seven overlapping containers 20 are arranged in a lateral direction. Thus, when the instant rice container separation apparatus 100 according to the present embodiment operates, seven containers 20 may be separated at once and may be supplied to the tray 10.

Of course, applying the 7-hole container-supplying master 120 is advantageous for improving productivity. However, the scope of rights of the present invention is not limited to these matters. That is, the container-supplying master 120 may have 6 holes or less or 8 holes or more.

Meanwhile, the instant rice container separation apparatus 100 according to the present embodiment is equipped with the integrated container separation plate 130, the separation plate forward-backward driving part 140, and a container adsorption unit 160 as a unit for separating the containers 20. As will be described below, the separation plate forward-backward driving part 140 and the container adsorption unit 160 are controlled to an organic mechanism by a device controller 190.

The integrated container separation plate 130 is disposed in a lower region of the container-supplying master 120 and separates the lowermost containers 20 disposed in the lateral direction from the containers 20 stacked thereon at once. This method is not an individual separation method in the related art so that 7 containers 20 can be separated by the integrated container separation plate 130 at once. Thus, this is structurally compact but productivity can be also improved.

In particular, in the present embodiment, the integrated container separation plate 130 is manufactured of aluminum. In the related art, a transfer cam (not shown) was made of MC nylon, so that foreign substances were generated during wear, but in the present embodiment, in order to solve this problem, the integrated container separation plate 130 is made of aluminum.

As shown in detail in FIG. 8, the integrated container separation plate 130 includes a separation plate body 131 formed as a plate body, and a plurality of container separation hole portions 132 which are arranged in rows at equal intervals on the separation plate body 131 and include a stepped locking portion 133 that catches one side when the containers 20 pass through the plurality of container separation hole portions 132. As described above, since the container-supplying master 120 has 7 holes, 7 container separation hole portions 132 are also formed. The seven container separation hole portions 132 have the same structure.

The stepped locking portion 133 has a stepped structure that is lower than the surface of the separation plate body 131. Thus, it is good for entering between the containers 20.

In the present embodiment, the container separation hole portion 132 is manufactured in an elliptical shape. Thus, an operation of separating the containers 20 becomes flexible.

In addition, an inclined surface 134 is further formed on the integrated container separation plate 130. The inclined surface 134 is formed on each container separation hole portions 132 and is inclined from the surface of the separation plate body 131 toward the stepped locking portion 133. Thus, it is advantageous to enter between the containers 20.

In the integrated container separation plate 130, a pair of connection flanges 135 are provided on both sidewalls of the separation plate body 131. The connection flange 135 is provided on each side wall of the separation plate body 131 and forms a place connected to the separation plate forward-backward driving part 140.

The separation plate forward-backward driving part 140 is connected to the integrated container separation plate 130 and is a unit for driving the integrated container separation plate 130 forward and backward.

This separation plate forward-backward driving part 140 includes a pair of separation plate supporting brackets 141 that support the integrated container separation plate 130 to be movable forward and backward on both sides of the integrated container separation plate 130, a separation forward-backward cylinder 142 that is mounted on the separation plate supporting bracket 141 and generates power for forward/backward movement of the integrated container separation plate 130, and a connector 143 that is connected to the separation forward-backward cylinder 142 and the integrated container separation plate 130 and delivers the power of the separation forward-backward cylinder 142 to the integrated container separation plate 130.

In the present embodiment, a job change separation plate 151 is further provided around the integrated container separation plate 130. The job change separation plate 151 is disposed between a pair of separation plate supporting brackets 141 and is used as a unit for job change. The structure of the job change separation plate 151 is the same as that of the integrated container separation plate 130.

Additionally, a job change air cylinder 153 is provided to automatically change the job change separation plate 151. The job change air cylinder 153 is a unit for driving the job change separation plate 151.

The container adsorption unit 160 is provided in the lower region of the integrated container separation plate 130 and serves to adsorb the lowermost containers 20 to be separated. Because the integrated container separation plate 130 and the container adsorption unit 160 interact, the containers 20 can be flexibly separated.

The container adsorption unit 160 may include a plurality of container adsorption pad units 161 that are arranged on the bottom of the containers 20 and adsorb the containers 20, an up/down slider 162 that supports the plurality of container adsorption pad units 161 integrally and is up/down driven together with the plurality of container adsorption pad units 161, a fixed support 163 that is spaced apart from the up/down slider 162 below the up/down slider 162 and fixed to the frame structure 111 of the apparatus body 110, an up/down driving actuator 164 that is mounted on the fixed support 163, connected to the up/down slider 162 and generates a driving force so that the up/down slider 162 can be up/down driven, and a plurality of up/down guides 165 that are connected to the up/down slider 162 and the fixed support 163 and guide an up/down operation of the up/down slider 162 based on the fixed support 163.

Flange brackets 166 for fixing to the frame structure 111 of the apparatus body 110 are connected to both sides of the fixed support 163. In addition, a bolt coupling structure 167 is connected to the fixed support 163 to firmly bolt the fixed support 163 to the frame structure 111 of the apparatus body 110.

Meanwhile, a device controller 190 is further mounted on the instant rice container separation apparatus 100 according to the present embodiment for control of the apparatus.

The device controller 190 controls an operation of the separation plate forward-backward driving part 140 and the container adsorption unit 160 so that the lowermost containers 20 can be separated from the stacked containers 20.

The device controller 190 that performs this role may include a central processing unit (CPU) 191, memory 192, and a support circuit 193.

In the present embodiment, the CPU 191 may be one of various computer processors that can be industrially applied to control the operation of a protection window sliding unit 140 so that a protection window may operate stepwise based on a detection signal of a detection unit 170 in the present embodiment.

The memory 192 is connected to the CPU 191. The memory 192, which is a computer-readable recording medium may be locally or remotely installed, and may be at least one type of memory that can easily be used, for example, random access memory (RAM), read-only memory (ROM), a floppy disk, a hard disk or an arbitrary digital storage form.

The support circuit 193 is combined with the CPU 191 and supports the typical operation of the processor. The support circuit 193 may include a cache, a power supply, a clock circuit, an input/output circuit, a sub-system, or the like.

In the present embodiment, the device controller 190 controls the operation of the protection window sliding unit 140 so that the protection window may operate stepwise based on the detection signal of the detection unit 170. At this time, a series of processes etc. in which the device controller 190 controls the operation of the protection window sliding unit 140 so that the protection window may operate stepwise based on the detection signal of the detection unit 170 may be stored in the memory 192. Typically, software routines may be stored in the memory 192. The software routines may also be stored or executed by another CPU (not shown).

Although the process according to the present invention has been described as being executed by software routines, it is also possible that at least some of the processes according to the present invention are performed by hardware. As such, the processes of the present invention may be implemented as software running on a computer system, as hardware such as an integrated circuit, or as a combination of software and hardware.

Hereinafter, the action of the instant rice container separation apparatus 100 will be described.

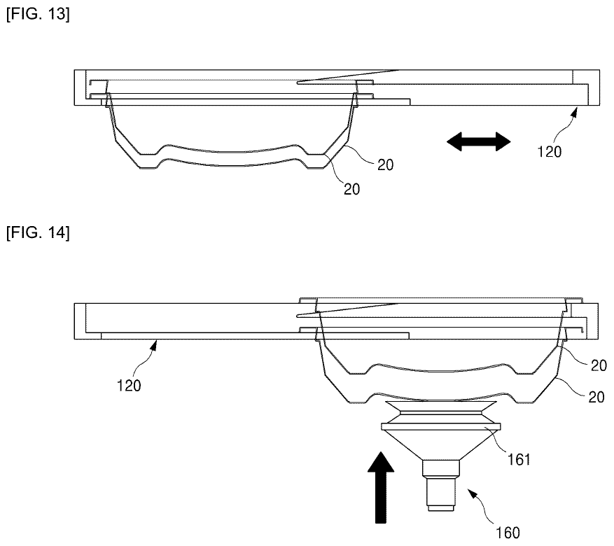

First, as shown in FIG. 12, in a state in which the containers 20 are stacked and then are located in a right position, the integrated container separation plate 130 moves forward owing to the action of the separation plate forward-backward driving part 140, as shown in FIG. 13.

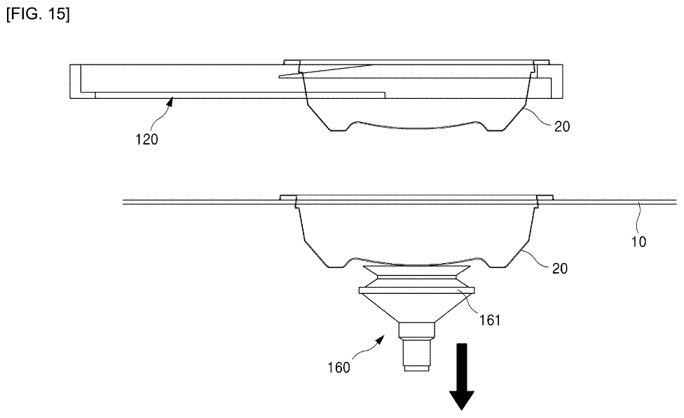

Next, as shown in FIG. 14, owing to the action of the container adsorption unit 160, the container adsorption pad unit 161 moves up and adsorbs the container 20. Then, as shown in FIG. 15, owing to the action of the container adsorption unit 160, the container adsorption pad unit 161 moves down and is seated on the tray 10. In this case, because the integrated container separation plate 130 moves forward, the containers 20 thereon do not fall.

According to the present embodiment, which operates with the structure described above, owing to a compact and efficient structure, the containers 20 can be effectively separated and disassembly and assembly can easily be performed so that a cleaning work can be conveniently performed and thus a production preparation time can be reduced and in addition, the possibility that foreign substances may be introduced into the containers 20, can be eliminated and the containers 20 can be safely protected from contamination.

As such, the present invention is not limited to the described embodiments, and it is obvious to those skilled in the art that various modifications and changes can be made without departing from the spirit and scope of the present invention. Therefore, it should be said that such modifications or variations fall within the scope of the claims of the present invention.

### EXPLANATION OF REFERENCE NUMERALS

1: instant rice container insertion unit
2: container presence detection device
3: container foreign substance removal device
4: supply device
5: washed rice chopping device
6: container discharge device
10: tray
20: container
30: tray conveyor
40: system body
60: steam pressurizing and sterilization device
70: cooking device
81: sealing device
82: treatment device
83: packaging device
100: instant rice container separation apparatus
110: apparatus body
111: frame structure
112: cover housing
120: container-supplying master
130: integrated container separation plate
131: separation plate body
132: container separation hole portion
133: stepped locking portion
134: inclined surface
135: connection flange
140: separation plate forward-backward driving part
141: separation plate supporting bracket
142: separation forward-backward cylinder
143: connector
151: job change separation plate
153: job change air cylinder
160: container adsorption unit
161: container adsorption pad unit
162: up/down slider
163: fixed support
164: up/down driving actuator
165: up/down guide
190: device controller

1. An instant rice container separation apparatus comprising:
a container-supplying master which is provided at one side of an apparatus body
and which allows a plurality of instant rice containers to be stacked in a height direction while overlapping and to be arranged in a lateral direction;
an integrated container separation plate which is disposed in a region below the container-supplying master, and which separates the lowermost containers, arranged in the lateral direction, all at once from the containers stacked thereon; and
a separation plate forward-backward driving part which is connected to the integrated container separation plate and which drives the integrated container separation plate forward and backward.

2. The instant rice container separation apparatus of claim 1, wherein the integrated container separation plate comprises:
a separation plate body formed as a plate body; and
a plurality of container separation hole portions which are arranged in rows at equal intervals on the separation plate body and comprise a stepped locking portion that catches one side when the containers pass through the plurality of container separation hole portions.

3. The instant rice container separation apparatus of claim 2, wherein each of the container separation hole portions is manufactured in an elliptical shape.

4. The instant rice container separation apparatus of claim 2, wherein the stepped locking portion has a stepped structure lower than the surface of the separation plate body, and an inclined surface is further formed on each of the container separation hole portions and is inclined from a surface of the separation plate body toward the stepped locking portion.

5. The instant rice container separation apparatus of claim 2, wherein the integrated container separation plate further comprises a pair of connection flanges provided on both sidewalls of the separation plate body and connected to the separation plate forward-backward driving part.

6. The instant rice container separation apparatus of claim 1, wherein the integrated container separation plate is manufactured of aluminum.

7. The instant rice container separation apparatus of claim 1, wherein the separation plate forward-backward driving part comprises:
a pair of separation plate supporting brackets that support the integrated container separation plate to be movable forward and backward on both sides of the integrated container separation plate;
a separation forward-backward cylinder that is mounted on the separation plate supporting bracket and generates power for forward/backward movement of the integrated container separation plate; and
a connector that is connected to the separation forward-backward cylinder and the integrated container separation plate and delivers power of the separation forward-backward cylinder to the integrated container separation plate.

8. The instant rice container separation apparatus of claim 7, wherein a job change separation plate for job change is further provided between the pair of separation plate supporting brackets, and the job change separation plate is driven by a job change air cylinder.

9. The instant rice container separation apparatus of claim 1, further comprising a container adsorption unit provided in a lower region of the integrated container separation plate and adsorbing the lowermost containers to be separated.

10. The instant rice container separation apparatus of claim 9, wherein the container adsorption unit comprises:
a plurality of container adsorption pad units arranged on a bottom of the containers and adsorbing the containers;
an up/down slider that supports the plurality of container adsorption pad units integrally and is up/down driven together with the plurality of container adsorption pad units;
a fixed support that is spaced apart from the up/down slider below the up/down slider and fixed to the frame structure of the apparatus body;
an up/down driving actuator that is mounted on the fixed support, connected to the up/down slider and generates a driving force so that the up/down slider can be up/down driven; and
a plurality of up/down guides that are connected to the up/down slider and the fixed support and guide an up/down operation of the up/down slider based on the fixed support.

11. The instant rice container separation apparatus of claim 9, further comprising a device controller that controls an operation of the separation plate forward-backward driving unit and the container adsorption unit so that the lowermost containers can be separated from the stacked containers.

12. An instant rice manufacturing system comprising:
a system body; and
an instant rice container separation apparatus provided at one side of the system body and separating and supplying instant rice containers in a stacked state,
wherein the instant rice container separation apparatus comprises:
a container-supplying master which is provided at one side of an apparatus body
and which allows a plurality of instant rice containers to be stacked in a height direction while overlapping and to be arranged in a lateral direction;
an integrated container separation plate which is disposed in a region below the container-supplying master, and which separates the lowermost containers, arranged in the lateral direction, all at once from the containers stacked thereon; and
a separation plate forward-backward driving part which is connected to the integrated container separation plate and which drives the integrated container separation plate forward and backward.
